(19) United States
(12) Patent Application Publication
(10) Pub. No.: US 2007/0013485 A1
(43) Pub. Date: Jan. 18, 2007

(54) RFID characterization method

(76) Inventors: Andrew W. Edwards, Irvine, CA (US); Richard E. Schumaker, Orange, CA (US); James P. Harkins, Lake Forest, CA (US); Duane C. Gibbs, Tustin, CA (US); Ricky D. Blanton, Lake Forest, CA (US)

Correspondence Address: MACPHERSON KWOK CHEN & HEID LLP, 2033 GATEWAY PLACE, SUITE 400, SAN JOSE, CA, 95110, US

(21) Appl. No.: 11/182,282

(22) Filed: Jul. 14, 2005

(51) Int. Cl. H04Q 5/22; G08B 5/22

(52) U.S. Cl. 340/10.5; 340/825.49

(57) ABSTRACT

An RFID system, such as an RFID printer system, is used to create an RFID performance profile by interrogating an RFID tag at a first position starting at a minimum RF power and increasing the RF power until a successful interrogation is obtained. The RFID tag is then moved forward into a next position and the interrogation process is repeated, starting at the minimum RF power. The process continues until the RFID tag is out of interrogation range even at a maximum RF power or some other user-defined stop point. The power level and position are stored at each position of the RFID tag during this process. The data is compiled to create a profile of the RF performance, which can then be used in a variety of ways to improve system performance.

### BACKGROUND

1. Field of the Invention

The present invention relates generally to methods of operating an RFID system, and more particularly to methods of encoding and reading RFID tags.

2. Related Art

The main function of printers is to deliver printed images. One example of printed images is bar code labels that are used in the supply chain for efficient processing and handling of goods in transit. Recent developments in technology allow Radio Frequency Identification (RFID) inlays (passive or active transponders) to be embedded in the bar code label. The transponder provides an electronic means of storing information and a non-contact, non-line of sight method for reading the stored data.

One common method for encoding RFID bar code labels is to use a printer/encoder. In such a system, an RFID encoder (sometimes called a reader) and antenna are integrated in the printer to enable both printing of the label information and programming of the RFID tag. RFID labels, such as for cartons or pallets, can be produced by embedding the RFID tag in a label, programming information into the tag, such as from a host computer, and based on the information, printing the label with a proper bar code and/or other printable information using the printer. RFID labels can also be produced in a printer by first printing on the label and then programming or encoding the RFID tag in the label. These labels can then be read by both a bar code scanner and an RFID reader. To ensure that the correct information is printed on a label, an RFID reader must be used to synchronize the thermal printing process with the associated RFID tag. Furthermore, the capabilities of programming and reading RFID tags used in thermal printer labels is limited, due in part, to the mechanical profile of the printer, which may cause performance issues with radio frequency signals associated with RFID technology, and to the proximity of multiple tags coupled with the need to address (program) only one tag at a time.

Thus, for printer/encoders to work well, a specialized antenna is usually required, due to the close proximity of the interrogation (encoding or reading) between antenna and RFID tag and between adjacent RFID tags. However, with an ever-increasing number of different antennas, tags, readers, and encoders, it is becoming more difficult to interrogate tags quickly and efficiently. For example, users may need to manually adjust the printer system, such as setting specific read/write parameters like power, to optimize operation for a particular roll of RFID labels.

Accordingly, it is desirable to have a performance profile of the RFID label/tag within a particular RFID printer system to enable the user or manufacture to increase performance.

### SUMMARY

According to one embodiment of the present invention, an RFID reader or encoder is set at its lowest RF power level for interrogation. The RFID tag is placed in a fixed position relative to the antenna. The RFID tag is then interrogated. If the interrogation was not successful, the RF power is increased and the tag is interrogated again. Once the RFID tag has been interrogated successfully, the RF power is recorded and the tag is moved forward a nominal distance, e.g., 0.1 inches. The RFID power is then set to the lowest level again and interrogation continues until a minimum RF power for a successful interrogation is obtained. This process continues until a write/read profile is created as the RFID tag is moved through the printer. Using the profile (in raw data or graphical format), the performance of the particular RFID tag/label within the printer system can be determined, which allows various optimization or performance improvements, such as tag placement within a label, antenna design, and interrogation parameters for a particular type of RFID tag or label. The data/graph could be uploaded to the host for later processing or printed out directly on the labels being profiled.

These and other features and advantages of the present invention will be more readily apparent from the detailed description of the preferred embodiments set forth below taken in conjunction with the accompanying drawings.

### BRIEF DESCRIPTION OF THE FIGURES

FIG. 1 is a block diagram of an RFID system for use with the present invention according to one embodiment;

FIG. 2 shows an RFID label and tag for use with the RFID system of FIG. 1 according to one embodiment;

FIG. 3 is a flow chart showing a process for creating an RF performance profile according to one embodiment of the present invention;

FIG. 4 is a plot showing the performance of one type of RFID tag; and

FIG. 5 is a plot showing the performance of another type of RFID tag.

Like element numbers in different figures represent the same or similar elements.

### DETAILED DESCRIPTION

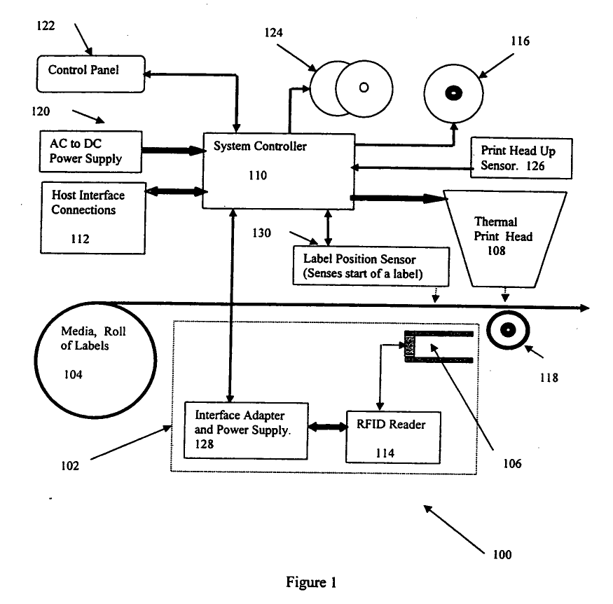

FIG. 1 shows a block diagram of a printer system 100 with a radio frequency identification (RFID) reader subsystem 102 that can be used to implement one method of the present invention. Printer system 100 also includes a roll 104 of labels or media, where an RFID tag is embedded in each label. In other embodiments, the roll of labels can be replaced by a short strip of RFID labels, sufficient to perform a profile/RF characterization, as will be discussed below. RFID tags are conventional passive tags available from a multitude of manufactures. One such manufacturer is Alien Technology Corporation of Morgan Hill, Calif. Labels from roll 104 are fed over an RFID antenna 106, programmed, and printed by a thermal print head 108. A host computer 112 coupled to a system controller 110 that is in turn coupled to RFID reader subsystem 102, which includes antenna 106, allows the RFID tag on each label to be written to, read, and verified. The resulting label then has both a printed media as well as a programmed RFID tag that can be read, such as with bar code scanners and RF readers, respectively.

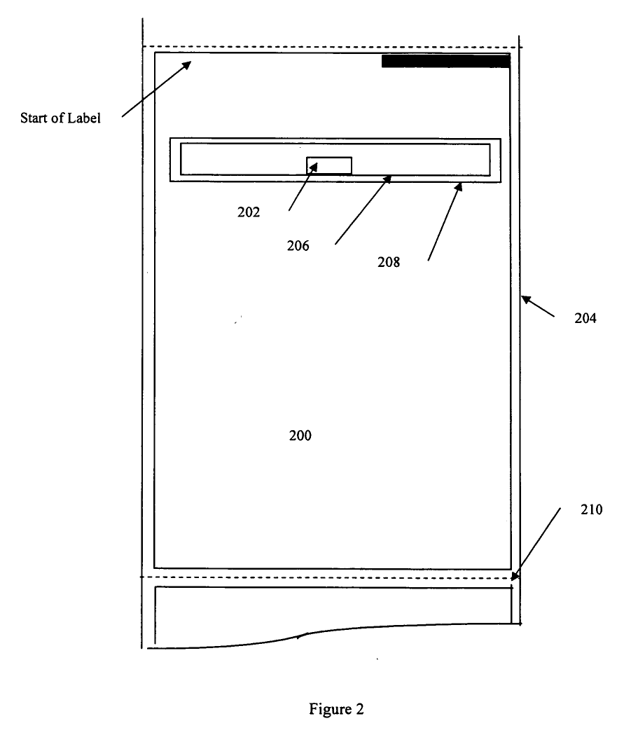

FIG. 2 shows a label 200 from roll 104 of FIG. 1, where label 200 includes an RFID tag 202. RFID tag 202, in one embodiment, is embedded in label 200 between a layer of wax paper or liner 204 and the adhesive side of label 200. An outline of an RFID antenna 206, associated with RFID tag 202, is also shown, along with the outline of an RFID tag assembly (inlay) 208, which is a conventional element. Also, as shown in FIG. 2, label 200 is one of many labels from roll 104, each label 200 can be separated from an adjacent label by a perforation 210. Perforation 210 allows labels to be easily separated after printing. RFID tag 202 can be located at any position on the label. As shown in one embodiment, RFID tag 202 is centered width-wise and approximately 1 inch from the top of a 4-inch label.

Referring back to FIG. 1, labels 200 from roll 104 pass over RFID antenna 106, during normal operation, for interrogation, where interrogation refers to writing (or encoding) to or reading from the RFID tag. A media drive motor 116, coupled to system controller 110, drives a platen 118 to pull labels 200 through the printer, as is known in the art. System controller 110 is also coupled to a power supply 120 and a user-operated control panel 122 that allows the user to control certain operations of the print system, as will be discussed below. System controller 110 also controls thermal ribbon drive motors 124 and receives information from a label position sensor 130, which allows system controller 110 to communicate the appropriate actions to other portions of the printer system. An interface adapter and power supply assembly 128 within RFID reader subsystem 102 provides power to RFID reader 114, which in turn powers RFID antenna 106. Interface adapter and power supply assembly 128 allows signals between system controller 110 and reader 114 to be received and transmitted.

The RFID antenna used in an RFID printer system is typically designed to meet the specific requirements of the application, e.g., reading and writing RFID tags in a small area with hundreds of RFID labels in close proximity to each other, i.e., in a roll. Examples of suitable antennas are disclosed in commonly-owned U.S. application Ser. Nos. 10/863,055 and 10/863,317, both filed Jun. 7, 2004 and are incorporated by reference in their entirety. Other antenna types may also be suitable, such as single transmission line antennas.

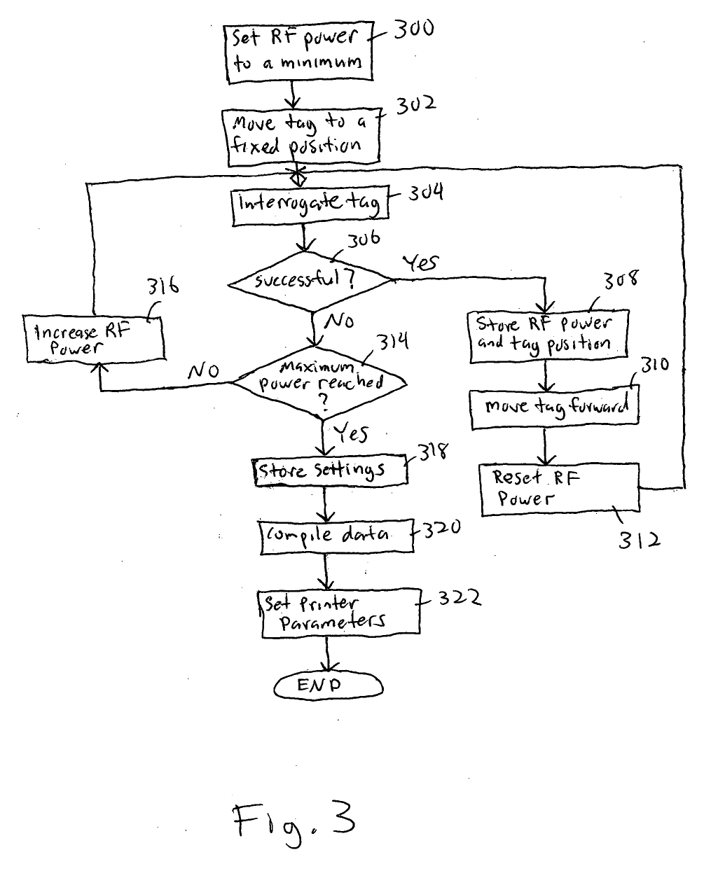

FIG. 3 is a flow chart showing steps used to profile an RFID tag or label 200 according to one embodiment. In step 300, the RF power for the RFID reader is set to its lowest interrogation power or highest attenuation. This can change from printer to printer and can be based on different factors, such as distance from reader to tag and type of antenna. The initial RF power setting is also dependent on whether the interrogation is a write or a read, where the latter generally requires less power.

A RFID tag in the roll is moved to a fixed position in front of the RFID antenna 106 in step 302, such as expressed in distance from the top-of-form (TOF) of the label. The RFID reader then attempts to interrogate the RFID tag in step 304, such as in response to a command sent to the RFID reader, such as directly or via the printer host interface. The interrogation, e.g., a read or programming operation, is checked, in step 306, to determine if the interrogation was successful, e.g., data was read or written correctly, such as by a comparison with known or expected data. One way is to read the encoded or written data and compare the data with the expected data. Different schemes can be used to determine whether the interrogation was successful. For example, a successful interrogation may be indicated if the printer system determines the tag was read or encoded correctly N times out of M, where N and M can be the same or different. Examples include N=M=1, N=M=3, N=3 and M=4.

If the interrogation operation was successful, the current RF power and position of the tag is stored in step 308. The tag is then moved forward in step 310 by a fixed amount, such as 0.1 inch, although other distances may also be suitable, depending various factors, such as system and tag parameters. The RF power in the RFID reader is reset in step 312 and the RFID tag is again interrogated in step 304 at this new position. Note that resetting or setting the RF power to a minimum level (steps 300 and 312) and moving the tag forward to a fixed position (steps 302 and 310) can be performed in any order, e.g., the power setting can be done first or the tag movement can be done first, or both can be done concurrently.

However, if as determined in step 306, the interrogation was not successful, a determination is made in step 314 whether the maximum RF power has been reached. If not, the RF power is increased in step 316, where the amount of increased power can be user specified or system dependent. Interrogation then continues at this higher power until either a successful interrogation is indicated (step 306) or the maximum power has been reached (step 314). This process continues as the RFID tag is moved forward incrementally. At some point, the RFID tag is moved so far away from the reader that even the maximum RF power will not be able to interrogate the tag successfully. At this point or when a set distance (such as defined by the user or system) has been reached, as determined in step 314, the settings are stored in step 318. Settings may include the distance from the reader, such as distance from TOF, and the power level, which would either be the RF power of a successful interrogation or the maximum RF power (if no successful interrogation was obtained). The user may also determine when the interrogations stop or manually inputs a maximum power, such as through a user interface.

This data is compiled, in step 320, resulting in a stored set of minimum RF powers that enable a successful interrogation at a specific position of the RFID tag and RF powers where successful interrogations were not possible. The compilation shows a profile of the interrogation, either a write cycle or a read cycle, reflecting the RF performance of the printer, antenna, and tag. The printer settings are optimized, in step 322, based on the data compilation. Consequently, when a roll of these RFID labels with associated RFID tags are read and written by the printer, the operating parameters are optimized over a range of interrogation distances at a minimum interrogation RF power. The RF performance profile can alternatively be used for purposes other than optimizing printer settings.

Accordingly, by using the compiled data and associated graphical images to profile an RFID tag within a printer system, numerous advantages are now possible. Examples include the ability to optimize the printer system and antenna design quickly and effectively, allow the determination of tag placement within a label for optimal RF performance for a specific tag, provide feedback to the tag vendor on tag performance, and enable reader performance evaluation.

The profiling process can be performed at a fixed frequency or at a different frequency for each write or read cycle. For example, frequency hopping can be between approximately 902 and 928 MHz inclusive in the ultra high frequency (UHF) band. Frequency hopping is known and is required by regulatory agencies such as the Federal Communications Commission (FCC) in order to minimize interference. This frequency range has a wavelength in free space between 13.9″ and 12.73″ inclusive. Other suitable RFID frequencies include 13.56 MHz in the HF band, 860 MHz and 950 MHz in the UHF band, and 2.45 GHz in the UHF band.

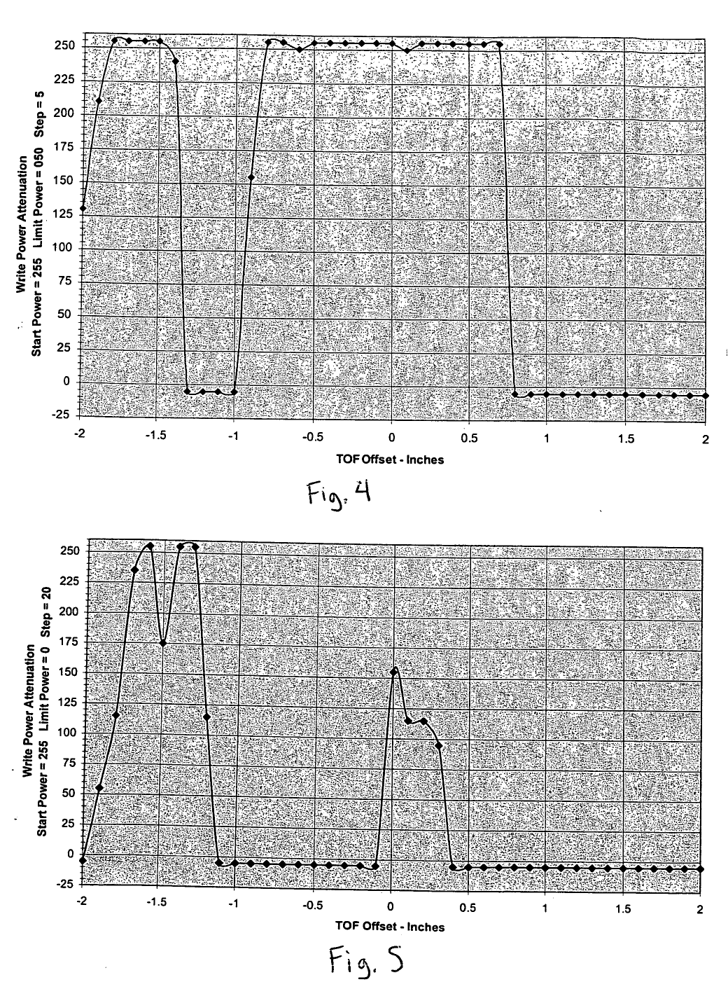

FIG. 4 is an exemplary plot of a data compilation according to one embodiment of the present invention for an Alien Squiggle tag embedded in a 4 inch by 6 inch label. The X-axis represents the distance from the top-of-form (TOF), and the Y-axis represents the RF attenuation, where the higher the attenuation, the lower the RF power. The “0” indicates the top-of-form in the printer. As seen from FIG. 4, with the RFID tag located 1.4 inches from top of form, minimal RF power is required over a range −0.8 inches to +0.7 inches around top-of-form. As such, the RFID tag placement would be considered to have ideal operating characteristics.

FIG. 5 is another plot for a different tag, i.e., a Rafsec 477 tag embedded in a 4 inch by 6 inch label. With this tag, around top-of-form, there is a very narrow band where the interrogation (here it was a write process) was successful. The flat-line performance elsewhere indicates full RF power would not enable writing to the tag. As a result, the profiling shows that this tag is poorly performing when used with the printer system.

Although the above description is based on a print system, the present invention can also be used on label applicators that apply RFID labels to cases and pallets in conveyor and similar supply chain systems. One difference is that there may be no printing on the label itself. The RF profiling and performance concerns are still relevant to ensure tags can be programmed successfully.

The host program that controls this process can be based on any application. Visual Basic provides a convenient method but other host applications could be used. The host computer controls the printer and in some cases the reader itself to perform the capabilities described. The data is exported to a file or directly to another application. The data can be formatted using any convenient application, such as Microsoft Excel.

Further, this application can be embedded in the printer firmware to allow the RF profile to be printed on the printer's bar code labels. This provides a tool for field diagnostics and for label converters (e.g., companies that embed RFID tags into commonly available labels on a volume basis) and other system integrators to perform real time tests without drawing on resources from the printer manufacturer. For example, this application can enable converters to qualify new tags in the printer without needing support from the printer manufacturer.

Thus, the RF profiling tool provides both an accurate and fast feedback for a variety of RF development purposes in a printer/encoders and label apply/encoder applicator systems.

Having thus described embodiments of the present invention, persons of ordinary skill in the art will recognize that changes may be made in form and detail without departing from the scope of the invention. Thus the invention is limited only by the following claims.

What is claimed is:

1. A method of operating a radio frequency identification (RFID) system, comprising:
(a) moving an RFID tag to a first position within the RFID system;
(b) interrogating the RFID tag at successively increasing RF powers until a successful interrogation is determined;
(c) storing the position and power information at a successful interrogation;
(d) moving the RFID tag forward within the RFID system;
(e) repeating operations (b) and (c); and
(f) creating a performance profile of the RFID system from the stored position and power information.

2. The method of claim 1, further comprising setting the RF power to a minimum power for interrogation for the RFID system prior to each position of the RFID tag.

3. The method of claim 1, wherein the interrogation is a write operation.

4. The method of claim 1, wherein the interrogation is a read operation.

5. The method of claim 1, further comprising repeating operations (d), (b), and (c) until the RFID tag is out of range for interrogation by the RFID system.

6. The method of claim 1, further comprising storing the position and power information if an interrogation is not successful at a maximum interrogation power.

7. The method of claim 1, wherein the RFID system is an RFID printer system.

8. The method of claim 1, wherein a successful interrogation is determined when N out of M interrogations are successful.

9. The method of claim 8, wherein N is equal to M.

10. The method of claim 8, wherein N is less than M.

11. The method of claim 8, wherein N and M are equal to one.

12. The method of claim 8, wherein each interrogation is performed at a fixed frequency.

13. The method of claim 8, wherein the interrogations are performed at different frequencies.

14. A method of creating a performance profile in a radio frequency identification (RFID) system using an RFID tag, the method comprising:
(a) setting a power for interrogation to a first RF power;
(b) moving the RFID tag into a first position;
(c) interrogating the RFID tag at the first RF power;
(d) determining whether the interrogation was successful; and
(e) if the interrogation was successful, storing the power and position information;
(f) if the interrogation was unsuccessful,
(i) increasing the power; and
(ii) interrogating the RFID tag at the higher power;
(iii) repeating operations (i) and (ii) until the interrogation is successful or a maximum power has been reached; and
(iv) storing the power and position information when the interrogation is successful or when a maximum power has been reached.

15. The method of claim 14, further comprising, after step (f):
setting the power back to the first RF power;
moving the RFID tag forward to a next position; and
repeating steps (c), (d), (e), and (f).

16. The method of claim 14, wherein the first RF power is a minimum power for the interrogation by the RFID system.

17. The method of claim 14, wherein the interrogation is a write operation.

18. The method of claim 14, wherein the interrogation is a read operation.

19. The method of claim 14, further comprising storing the power and position information until the RFID tag cannot be successfully interrogated at a maximum interrogation power.

20. The method of claim 14, wherein the RFID system is an RFID printer system.

21. The method of claim 14, wherein the determining comprises testing the interrogation M times and indicating a successful interrogation if N out of the M interrogations were successful.

22. The method of claim 21, wherein N is equal to M.

23. The method of claim 21, wherein N is less than M.

24. The method of claim 21, wherein N and M are equal to one.

25. The method of claim 15, wherein each interrogation is performed at a fixed frequency.

26. The method of claim 15, wherein the interrogations are performed at different frequencies.
